(19) United States
(12) Patent Application Publication
(10) Pub. No.: US 2026/0171766 A1
(43) Pub. Date: Jun. 18, 2026

(54) RECONFIGURABLE CHUTE SYSTEM FOR INSTALLATION OF NARROW CONTINUOUS ELONGATED TUBULAR MATERIAL IN THE GROUND

(71) Applicant: ROBERTS WELDING & FABRICATING LTD., Woodstock (CA)

(72) Inventors: Robert W. H. HALL, Embro (CA); Gregory James BALL, Ingersoll (CA); Michael David ROSS, Paris (CA)

(73) Assignee: ROBERTS WELDING & FABRICATING LTD., Woodstock (CA)

(21) Appl. No.: 19/421,005

(22) Filed: Dec. 16, 2025

Related U.S. Application Data
(60) Provisional application No. 63/734,942, filed on Dec. 17, 2024.

(51) Int. Cl. H02G 1/08

(52) U.S. Cl. CPC H02G 1/08

(57) ABSTRACT

A reconfigurable chute system for installing continuous elongated tubular material from a plow into the ground involves a plurality of inserts, each insert having a duct through which the tubular material is fed, each duct having a curved section that directs the continuous elongated tubular material from a substantially vertical orientation at an entrance to the duct downwardly and rearwardly to a substantially horizontal orientation at an exit from the duct. The plurality of inserts involves at least a first insert and a second insert, the second insert having a narrower width than the first insert, the second insert nestable with and removably mountable to the first insert while providing a sufficiently large gap in the duct of the first insert between internal walls of the first insert and external surfaces of the second insert to permit feeding of the elongated tubular material through the duct of the first insert.

### CROSS REFERENCE TO RELATED APPLICATIONS

This application claims the benefit of U.S. Provisional Patent Application No. 63/734,942, filed Dec. 17, 2024, the entire contents of which are herein incorporated by reference.

### FIELD

This application relates to systems and apparatuses for laying elongated tubular materials in the ground.

### BACKGROUND

Systems for laying conduit in the ground are known in the art, for example U.S. Pat. No. 8,047,744 issued Nov. 1, 2011 and U.S. Pat. No. 11,612,095 issued Mar. 28, 2023, the entire content of both of which are hereby incorporated by reference. While such systems can be designed for laying any particular type of conduit, the chutes of such systems are designed for the particular type of conduit to be laid. A different chute must be utilized when laying a conduit for which the chute is not designed. Especially when laying narrow-gauge conduit, such as fiber optic cable, coaxial cable, ethernet cable and the like, it is desirable to be able to utilize the same chute for simultaneously laying any combination of types of cables.

There remains a need in the art for a reconfigurable system for simultaneously installing any combination of different types of continuous elongated tubular material in the ground using the same chute at different depths.

### SUMMARY

A reconfigurable chute system for installing continuous elongated tubular material from a plow into the ground comprises a plurality of inserts, each insert comprising at least one side wall defining a duct through which a continuous elongated tubular material is fed, each duct having a curved section that directs the continuous elongated tubular material from a substantially vertical orientation at an entrance to the duct downwardly and rearwardly to a substantially horizontal orientation at an exit from the duct, wherein the plurality of inserts comprises at least a first insert and a second insert, the second insert having a narrower width than the first insert, the second insert nestable with and removably mountable to the first insert while providing a sufficiently large gap in the duct of the first insert between internal walls of the first insert and external surfaces of the second insert to permit feeding of the continuous elongated tubular material through the duct of the first insert.

A plow for installation of continuous elongated tubular material in the ground comprises a plow blade and the chute system described above mounted on the plow blade.

An insert for a reconfigurable chute system for installing continuous elongated tubular material from a plow into the ground comprises at least one side wall defining a duct through which a continuous elongated tubular material is fed continuously. An insert is an element of the chute system, which comprises a duct through which the continuous elongated tubular material can be fed continuously. In some embodiments, the continuous elongated tubular material is fed into a top of the insert and follows the duct down the insert to exit the insert at a bottom thereof. During the installation, the plow is mounted on a vehicle, which tows the plow, and a plow blade of the plow located forward of the bottom of the insert creates a trench in the ground ahead of the bottom of the insert. The bottom of the insert is situated within the trench while the continuous elongated tubular material is fed through the insert and the vehicle tows the plow. As the continuous elongated tubular material exits the bottom of the insert into the trench, a trench re-filler located rearward of the insert covers the continuous elongated tubular material in the trench.

As used herein, the term ‘longitudinal’ means a direction parallel to a direction of travel of the plow while the plow is being towed. The terms ‘front’ and ‘forward’ are longitudinal directions in the direction of travel while the terms ‘rear’ and ‘rearward’ are longitudinal directions away from the direction of travel. The term ‘lateral’ means a direction perpendicular to the direction of travel of the plow.

The reconfigurable chute system described herein comprises a plurality of inserts. The reconfigurable chute system may comprise 2, 3, 4, 5, 6 or more inserts with corresponding ducts. In some embodiments, the reconfigurable chute system includes a first insert in which others of the plurality of inserts are insertable in a nesting arrangement. The number of inserts is limited only by a lateral width of the first insert and a lateral width of the trench created by the plow. The width of the trench is the lateral distance between parallel edges of the trench. The inserts have an external width and an internal width. The external width of a narrower insert is less than the internal width of a wider insert. Nested inserts are successively narrower in width to permit multiple inserts to be nested within each other from a widest insert to a narrowest insert. In some embodiments, the widest insert is closest to the plow blade while the other inserts are successively narrower and nested in a rearward direction from the widest insert. Thus, in some embodiments, the ducts of successively nested inserts from the first widest insert to a last narrowest insert are disposed rearwardly of each other. However, the reverse may be true in other embodiments. In some embodiments, the first insert is the widest insert. In some embodiments, the first insert is mounted on the plow blade. In some embodiments, the first insert is mounted on a rear the plow blade. In some embodiments, the second insert is nested with the first insert and is located to a rear of the first insert. The insert-within-insert arrangement permits simultaneously installation in the ground of different instances of the same continuous elongated tubular materials and/or different types of continuous elongated tubular materials at different depths.

In some embodiments, the chute system comprises a third insert having a narrower width than the first insert and the second insert. The third insert is removably mountable in either the first insert or the second insert to create different configurations of the chute system. In some embodiments, the chute system comprises fourth, fifth or more inserts having different widths to create more permutations of nested insert configurations. The inserts are removably mounted to each other thereby permitting different configurations of inserts in the chute system to meet specific needs for laying continuous elongated tubular material.

The inserts of the chute system are removably mountable to each other while providing a sufficiently large gap in the duct of the wider insert between internal surfaces of the wider insert and external surfaces (e.g., a front-facing surface) of the narrower insert to permit feeding of the continuous elongated tubular material through the wider insert. For example, in some embodiments, the third insert is nestable with and removably mountable to the first insert and the second insert while providing a sufficiently large gap in the duct of the first insert or the second insert between internal walls of the first insert or the second insert and external surfaces of the third insert to permit feeding of the continuous elongated tubular material through the first insert or the second insert. In some embodiments, the inserts and therefore the continuous elongated tubular material in the ducts of the inserts are disposed longitudinally to each other. However, the inserts and therefore the continuous elongated tubular material in the inserts may be disposed transversely if the trench is wide enough.

The inserts and the ducts in the inserts may have any suitable cross-sectional shape, for example circular, oval, square rectangular and the like. At least the widest insert has a duct with an open face with which the others of the inserts are nestable. Other narrower inserts may also have ducts with open faces with which even narrower inserts are nestable. With the wider inserts, the open faces of the ducts therein are blocked by external surfaces of the inserts nested therewith to confine the continuous elongated tubular materials in the wider inserts. In some embodiments, the narrowest insert has an enclosed duct (e.g., the narrowest insert comprises a tube) to ensure that the continuous elongated tubular material remains confined within the duct. In some embodiments, the third insert comprises a tube defining the duct of the third insert. In some embodiments, where the narrowest insert (e.g., the third insert) comprises a tube, the tube is mounted on a mounting frame connected to the tube. In some embodiments, the mounting frame comprises an external surface (e.g., a front-facing external surface), the mounting frame nestable with and removably mountable to one or more of the other inserts (e.g., the first insert and the second insert).

The inserts are removably mountable to each other so that the chute system can be variously configured on the plow. Any suitable means may be used to removably mount the inserts to each other, for example pins, clamps and the like. In some embodiments, the inserts are removably mountable with pinned connections. Pinned connections comprise one or more pins. The one or more pins may be threaded pins (e.g., bolts, screws and the like) and/or unthreaded pins. In some embodiments, the pinned connections comprise pins connecting tops of successively nested inserts to each other. In some embodiments, the pin or pins connecting two inserts at the tops thereof go through a top back edge of one of the inserts (e.g., the wider insert) and a top front edge of the other of the inserts (e.g., the narrower insert) so that the two inserts are only barely nested with each other while providing the sufficient gap into which continuous elongated tubular material can be fed.

In some embodiments, a wider insert comprises a hook on a face thereof (e.g., a rear face or a front face) and proximate a bottom end thereof in which a connecting pin mounted to a narrower insert is releasably retained to removably mount the narrower insert to the wider insert. In some embodiments, the wider insert comprises a hook on a face thereof (e.g., a rear face or a front face), proximate a middle thereof and before the curved section of the duct in which another connecting pin mounted to the narrower insert is releasably retained to removably mount the narrower insert to the wider insert. In some embodiments where there are at least three inserts in the chute system and the inserts are successively narrower rearwardly, a first insert or a second insert comprises a hook on a rear face thereof and proximate a bottom end thereof in which a connecting pin mounted to a third insert is releasably retained to removably mount the third insert to the first insert or the second insert. Also, in some embodiments where there are at least three inserts in the chute system and the inserts are successively narrower rearwardly, the first insert or the second insert comprises a hook on a rear face thereof, proximate a middle thereof and before the curved section of the duct in which another connecting pin mounted to the third insert is releasably retained to removably mount the third insert to the first insert or the second insert. In some embodiments, non-threaded pins are used instead of threaded pins at bottom of the inserts because the bottoms of the inserts are in the ground during use. In some embodiments, threaded pins (e.g., bolts) are used above ground-level.

In some embodiments, one or more of the inserts comprises a plurality of slide plates spanning a width of the duct inside the insert. The plurality of slide plates provides a guide for the continuous elongated tubular material while being fed through the duct of an insert to help prevent kinking and jamming of the continuous elongated as the continuous elongated is fed through the insert. For narrow-gauge and somewhat flexible continuous elongated tubular material, rollers in the insert are unnecessary.

One of the inserts (e.g., the first insert) of the chute system is mountable to a blade of the plow while the other inserts are mounted to the insert mounted on the plow in a successively nested manner. In some embodiments, the chute system is mounted on a rear of the plow blade. The chute system is immovably or movably mounted on the plow blade. In some embodiments, the chute system is immovably mounted on the plow blade by welding, bolting or the like. In some embodiments, the chute system is pivotably mounted on the plow blade, for example with a hinged connection of one of the inserts with the plow blade.

The reconfigurable chute system described herein can be mounted on a plow to permit the installation of any combination of different types of narrow continuous elongated tubular material in the ground using the same plow. Thus, the same plow can be used for simultaneously laying any combination of narrow continuous elongated tubular material. Each of the inserts in the chute system when mounted on the plow can feed the same or a different type of continuous elongated tubular material as the other inserts. The reconfigurable chute system described herein is most suitable for narrow continuous elongated tubular material. (e.g., fiber optic cable, coaxial cable, ethernet cable and the like), and less suitable for wide continuous elongated tubular material (e.g., drainage tile, triplex electrical cable and the like). Prior art chute systems on plows often utilize rollers in the inserts to ensure that the tubular material slides smoothly through the insert without kinking or becoming stuck. The reconfigurable chute system described herein does not require rollers because the narrow continuous elongated tubular materials are more flexible than the wide continuous elongated tubular material. In comparison to wide continuous elongated tubular material, narrow continuous elongated tubular material is generally more impermeable to water, more flexible and has a smaller bend radius.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts a rear perspective view of a first configuration of a reconfigurable chute system for narrow continuous elongated tubular material on a plow, the first configuration comprising three inserts.

FIG. 1B depicts a side view of the first configuration shown in FIG. 1A.

FIG. 2 depicts an exploded view of the first configuration shown in FIG. 1A.

FIG. 3 depicts an isometric view of the first configuration shown in FIG. 1A in context with a plow blade and other elements of the plow.

FIG. 4A depicts a rear perspective view of a second configuration of the reconfigurable chute system comprising two inserts.

FIG. 4B depicts a side view of the second configuration shown in FIG. 4A.

FIG. 5 depicts an exploded view of the second configuration shown in FIG. 4A.

FIG. 6A depicts the first configuration shown in FIG. 3 pivotably mounted to the plow blade.

FIG. 6B depicts a side view of FIG. 6A.

FIG. 7 depicts a perspective view of a system for installation of continuous elongated tubular material in the ground, the system including a crawler tractor, a plow mount and a plow.

### DETAILED DESCRIPTION

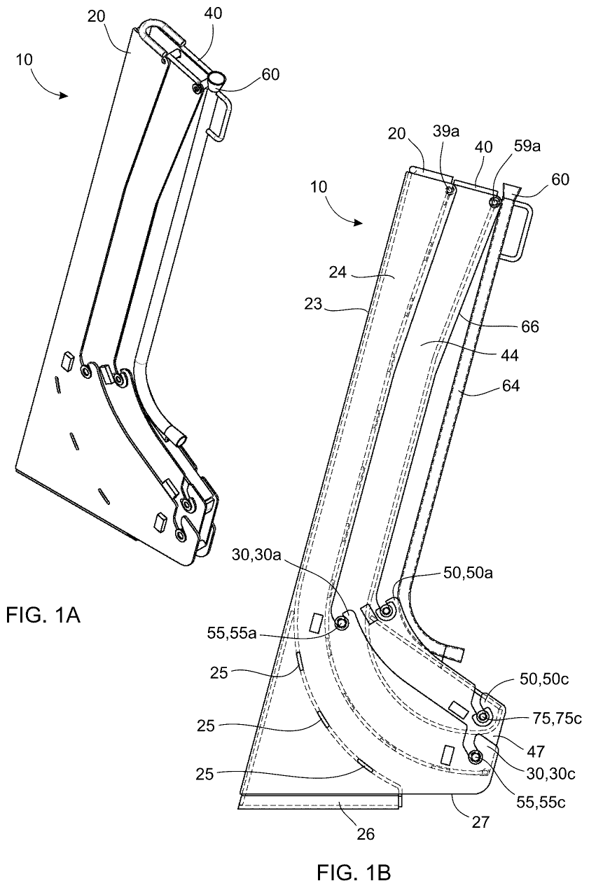

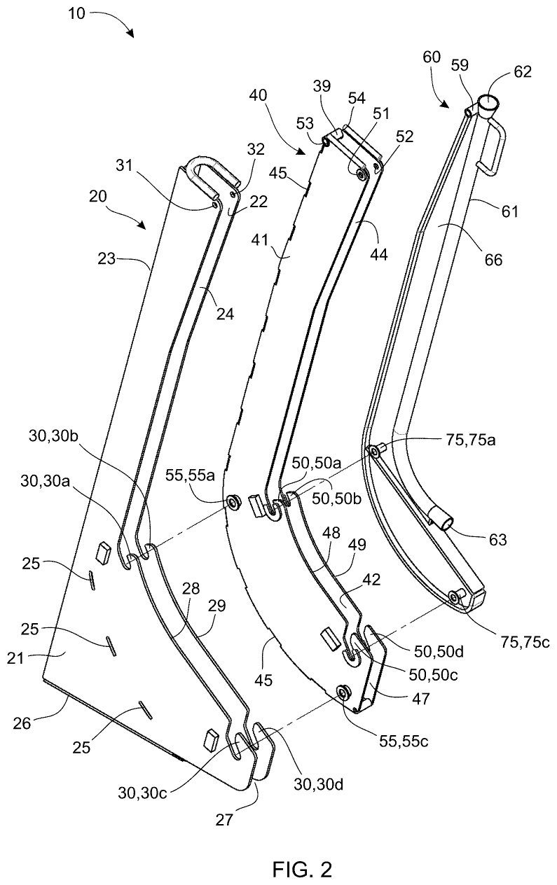

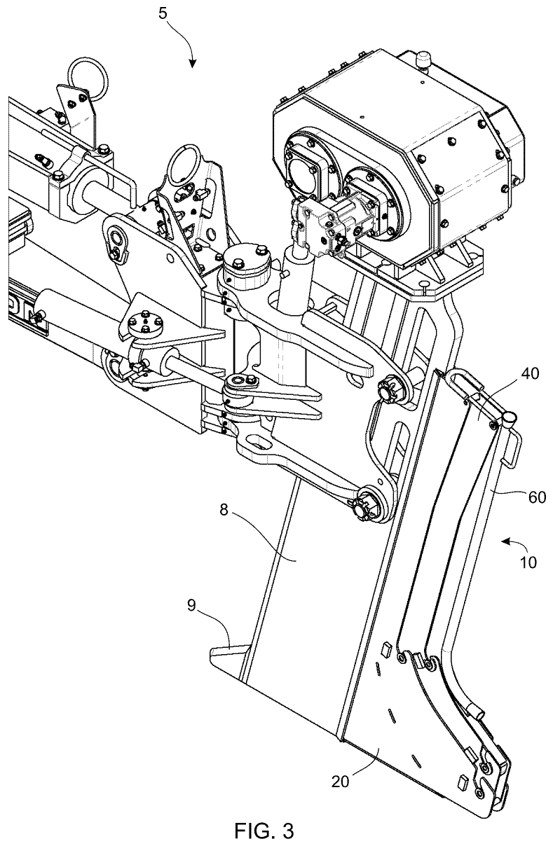

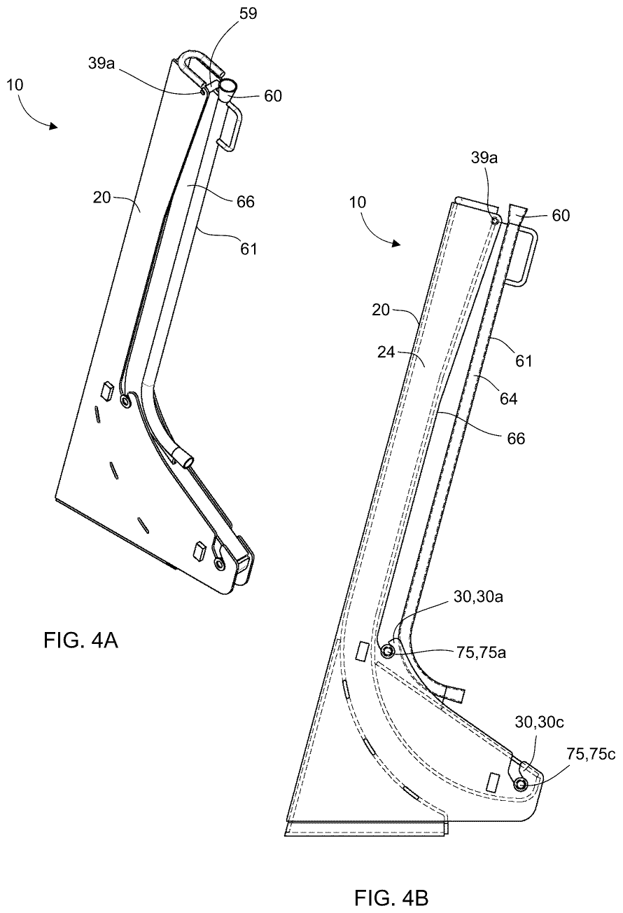

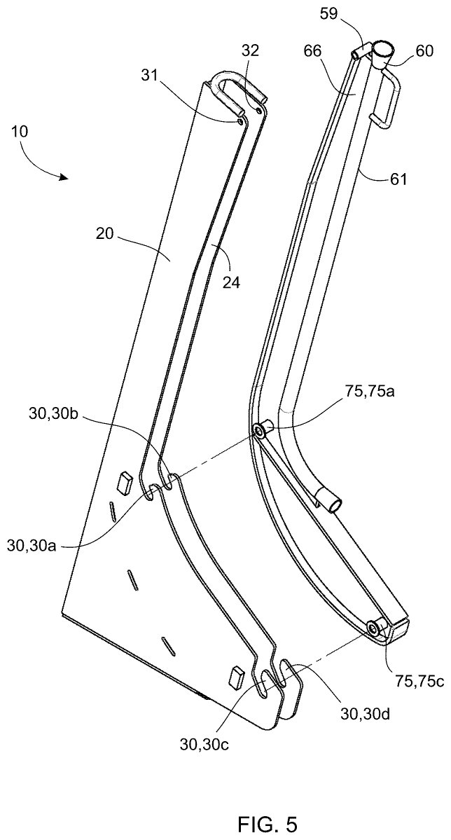

With reference to FIG. 1A to FIG. 3, a first configuration of a reconfigurable chute system 10 for narrow continuous elongated tubular material on a plow comprises three nested inserts including a first insert 20, a second insert 40 and a third insert 60. The first insert 20 is mounted by welding onto a rear of a plow blade 8 of a plow 5 as seen in FIG. 4 and FIG. 5. A blade tip 9 of the plow blade 8 points forward, the blade tip 9 opening a furrow in the ground for the blade 8 to widen so that continuous elongated tubular material being fed into tops of the inserts 20, 40, 60 can be installed in the furrow at bottom of the inserts 20, 40, 60.

The first insert 20 comprises laterally opposed walls 21, 22 that form a first duct 24 therebetween. The first duct 24 is open at a rear of the first insert 20 but is closed at a front of the first insert 20 by a forward-facing wall 23, the forward-facing wall 23 having a rear surface facing into the first duct 24. The first insert 20 is substantially L-shaped having a substantially vertically-oriented leg portion and a substantially horizontally-oriented foot portion extending rearwardly from the leg portion. The first duct 24 follows a path from a top of the leg portion at the top of the first insert 20 to a rearward end of the foot portion at the bottom of the first insert 20. The first duct 24 is substantially vertically-oriented in the leg portion and substantially horizontally-oriented in the foot portion of the first insert 20 but has a curved section where the leg portion transitions into the foot portion of the first insert 20. To assist with forming the curved section of the first duct 24, the first insert 20 is provided with a series of slide plates 25 spanning a width of the first duct 24 inside the first insert 20 and following a curved path from the leg section to the foot section of the first insert 20. The slide plates 25 help prevent jamming and kinking of the continuous elongated tubular material at the bottom of the first insert 20. The bottom of the first insert 20 is provided with a skid plate 26, which both partially closes the first duct 24 at the bottom thereof and provides a lower ground-contacting surface for the chute system 10 during an installation operation. Continuous elongated tubular material being fed through the first insert 20 exits the first insert 20 through a bottom open portion 27 of the first duct 24 in the foot section of the first insert 20.

Rearward edges 28, 29 of the walls 21, 22, respectively, of the first insert 20 are provided with hooks 30 that interact with the second insert 40 to assist with removable but secure nesting of the second insert 40 with the first insert 20. The hooks 30 comprise slots for accepting pins that become nestled between lower portions of the rearward edges 28, 29 and upper recurved portions of the rearward edges 28, 29. The hooks 30 comprise a middle set of hooks 30a, 30b located before the curved section of the first duct 24 and a bottom set of hooks 30c, 30d located at the rearward end of the foot section at the bottom of the first insert 24.

At the top of the first insert 20, the opposed walls 21, 22 comprise laterally opposed through apertures 31, 32, respectively, through which a first connecting pin 39a is inserted to removably mount the second insert 40 to the first insert 20. The through apertures 31, 32 are located proximate the rearward edges 28, 29, respectively, of the laterally opposed walls 21, 22, respectively, of the first insert 20. The location of the through apertures 31, 32 permits nesting of the second insert 40 with the first insert 20 but only barely so that there is a sufficient gap between a front face of the second insert 40 and the rear surface of the forward-facing wall 23 of the first insert 20 to form the first duct 24 in the first insert 20.

The second insert 40 comprises laterally opposed walls 41, 42 that form a second duct 44 therebetween. The second duct 44 is open at a rear of the second insert 40 but is partially closed at a front of the second insert 40 by a series of lateral plates fitted into a corresponding series of indentations 45 (only two labeled) in front edges of the opposed walls 41, 42 and spanning the width of the second insert 40 between the opposed walls 41, 42 to separate the second duct 44 from the first duct 24 so that continuous elongated tubular material being fed through the first insert 20 does not impinge into the second insert 40. During operation, the continuous elongated tubular material rides on front faces of the lateral plates as the plow 5 is towed forward and the continuous elongated tubular material in the first insert 20 is laid rearwardly. The second insert 40 is substantially L-shaped having a substantially vertically-oriented leg portion and a substantially horizontally-oriented foot portion extending rearwardly from the leg portion. The second duct 44 follows a path from a top of the leg portion at the top of the second insert 40 to a rearward end of the foot portion at the bottom of the second insert 40. The second duct 44 is substantially vertically-oriented in the leg portion and substantially horizontally-oriented in the foot portion of the second insert 40 but both the second duct 44 and the second insert 40 have a curved section where the leg portion transitions into the foot portion of the second insert 40. Continuous elongated tubular material being fed through the second insert 40 exits the second insert 40 through a bottom open portion 47 of the second duct 44 in the foot section of the second insert 40.

At the top of the second insert 40, the opposed walls 41, 42 comprise laterally opposed through apertures 53, 54, respectively, connected by a first hollow cylinder 39 and through which the first connecting pin 39a is inserted to removably mount the second insert 40 to the first insert 20. The through apertures 53, 54 are located at the front edges of the laterally opposed walls 41, 42, respectively, of the second insert 40. The lateral external width of the second insert 40 is narrower than the lateral internal width of the first insert 20. Therefore, when mounting the second insert 40 to the first insert 20, the second insert 40 is inserted part way into the first duct 24 in a nested manner so that the through apertures 31, 32, 53 and 54 are all aligned and the first connecting pin 39a is inserted through all four of the through apertures 31, 32, 53 and 54 and the first hollow cylinder 39 to removably mount the second insert 40 to the first insert 20.

The second insert 40 further comprises four auxiliary mounting pins 55 (only two labeled) that engage the hooks 30 of the first insert 20 to further securely mount the second insert 40 to the first insert 20 in a nested manner. The auxiliary mounting pins 55 are located on and extend laterally from external surfaces of the opposed walls 41, 42 proximate the front edges of the opposed walls 41, 42. The auxiliary mounting pins 55 comprise a middle set of auxiliary mounting pins (only one labeled as 55a) that are located to engage the middle set of hooks 30a, 30b of the first insert 20, and a bottom set of auxiliary mounting pins (only one labeled as 55c) that are located to engage the bottom set of hooks 30c, 30d of the first insert 20. When mounting the second insert 40 to the first insert 20, the auxiliary mounting pins 55 the second insert 40 are inserted into the tops of the slots of the corresponding hooks 30 of the first insert 20 and come to rest at bottoms of the hooks 30. The auxiliary mounting pins 55 comprises heads that are larger than a width of the slots of the hooks 30 to help secure the auxiliary mounting pins 55 in the hooks 30.

Rearward edges 48, 49 of the walls 41, 42, respectively, of the second insert 40 are also provided with hooks 50 that interact with the third insert 60 to assist with removable but secure nesting of the third insert 60 with the second insert 40. The hooks 50 comprise slots for accepting pins that become nestled between lower portions of the rearward edges 48, 49 and upper recurved portions of the rearward edges 48, 49. The hooks 50 comprise a middle set of hooks 50a, 50b located before the curved section of the second duct 44 and a bottom set of hooks 50c, 50d located at the rearward end of the foot section at the bottom of the second insert 44.

At the top of the second insert 40, the opposed walls 41, 42 comprise laterally opposed through apertures 51, 52, respectively, through which a second connecting pin 59a is inserted to removably mount the third insert 60 to the second insert 40. The through apertures 51, 52 are located proximate the rearward edges 48, 49, respectively, of the laterally opposed walls 41, 42, respectively, of the second insert 40. The location of the through apertures 51, 52 permits nesting of the third insert 60 with the second insert 20 but only barely so that there is a sufficient gap between a front face of the third insert 60 and the rear surfaces of the lateral plates of the second insert 40 to form the second duct 44 in the second insert 40.

The third insert 60 comprises an enclosed tube 61 of circular cross-section defining a third duct 64 having a substantially vertically-oriented top opening 62 into which continuous elongated tubular material is fed and a more horizontally-oriented bottom opening 63 out of which the continuous elongated tubular material exits rearwardly. The third insert 60 also comprises a mounting frame 66 connected to the tube 61 forward of the tube 61. The mounting frame 66 comprises an external front-facing surface of the third insert 60. The mounting frame is nestable with and removably mountable to the second insert 40 as described below. The front-facing surface of the third insert 60 blocks the open rear of the second insert 40 so that continuous elongated tubular material being fed through the second insert 40 remains in the second duct 44 and has a surface to ride on while being fed through the second insert 40.

The third insert 60 is substantially L-shaped having a substantially vertically-oriented leg portion and a more horizontally-oriented foot portion extending rearwardly from the leg portion. The tube 61 and therefore the third duct 64 follows a path from a top of the leg portion at the top of the third insert 60 to a rearward end of the foot portion at the bottom of the third insert 60. The tube 61, and therefore the third duct 64, is substantially vertically-oriented in the leg portion and more horizontally-oriented in the foot portion of the third insert 60 but both the tube 61 and the mounting frame 66 have a curved section where the leg portion transitions into the foot portion of the third insert 60. The continuous elongated tubular material being fed through the third insert 60 exits the third insert 60 through the bottom opening 63 of the tube 61 in the foot section of the third insert 60.

At the top of the third insert 60, the mounting frame 66 comprises a laterally-oriented second hollow cylinder 59 through which a second connecting pin 59a is inserted to removably mount the third insert 60 to the second insert 40. The lateral external width of the mounting frame 66 is narrower than the lateral internal width of the second insert 40. Therefore, when mounting the third insert 60 to the second insert 40, the mounting frame 66 is inserted part way into the second duct 44 in a nested manner so that the second hollow cylinder 59 and the through apertures 51, 52 are all aligned and the second connecting pin 59a is inserted through second hollow cylinder 59 and the through apertures 51, 52 to removably mount the third insert 60 to the second insert 40.

The third insert 60 further comprises four auxiliary mounting pins 75 (only two labeled) that engage the hooks 50 of the second insert 40 to further securely mount the third insert 60 to the second insert 40 in a nested manner. The auxiliary mounting pins 75 are located on and extend laterally from external lateral surfaces of the mounting frame 66 proximate the front-facing surface of the mounting frame 66. The auxiliary mounting pins 75 comprise a middle set of auxiliary mounting pins (only one labeled as 75a) that are located to engage the middle set of hooks 50a, 50b of the second insert 40, and a bottom set of auxiliary mounting pins (only one labeled as 75c) that are located to engage the bottom set of hooks 50c, 50d of the second insert 50. When mounting the third insert 60 to the second insert 40, the auxiliary mounting pins 75 the third insert 60 are inserted into the tops of the slots of the corresponding hooks 50 of the second insert 40 and come to rest at bottoms of the hooks 50. The auxiliary mounting pins 75 comprises heads that are larger than a width of the slots of the hooks 50 to help secure the auxiliary mounting pins 75 in the hooks 50.

With reference to FIG. 4A to FIG. 5, a second configuration of the reconfigurable chute system 10 comprises two nested inserts including the first insert 20 and the third insert 60. The external width of the mounting frame 66 of the third insert 60 is narrower than the internal width of the first insert 20. Further, the auxiliary mounting pins 75 of the the third insert 60 are sufficiently long to engage the hooks 30 of the first insert 20 when the third insert 60 is nested with the first insert 20. Therefore, the third insert 60 is nestable directly with the first insert 20 by inserting the second pin 39a through the through apertures 31, 32 and the second hollow cylinder 59.

With proper design of the external and internal widths of the inserts and the lengths of the mounting pins, the reconfigurable chute system 10 may comprise any number of nestable inserts that can be used in various combinations to accommodate the desired types of continuous elongated tubular material for a particular job without needing to use a different plow altogether.

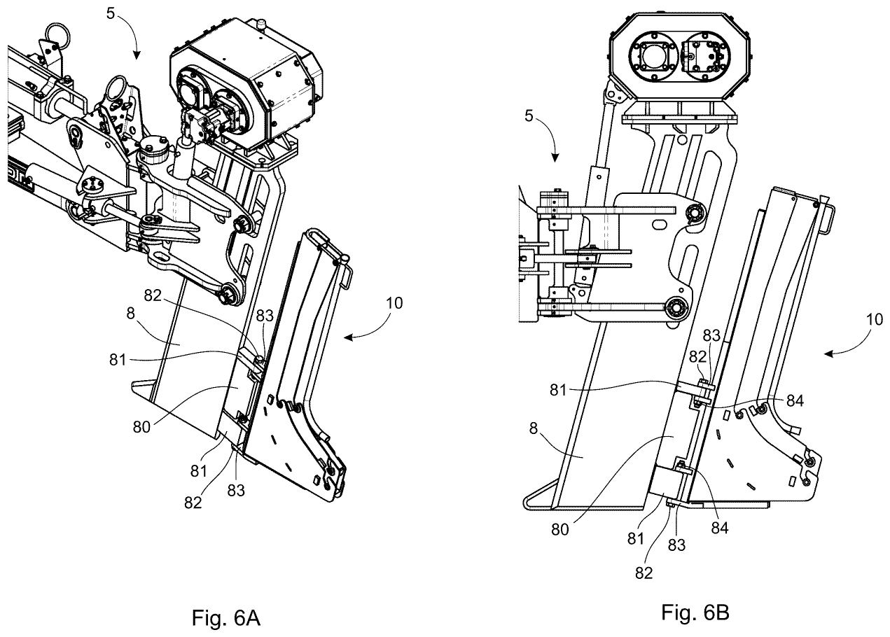

With reference to FIG. 6A and FIG. 6B, in another embodiment, the reconfigurable chute system 10 is pivotably mounted to the plow 5 instead of being welded. In this embodiment, the plow 5 is provided with a mounting plate 80 extending rearwardly from a rear edge of the plow blade 8. The mounting plate 80 comprises upper and lower flanges 81 having aligned apertures through which upper and lower pivot pins 82, respectively, are insertable. The reconfigurable chute system 10 is provided with corresponding upper and lower clevises 83 extending forwardly from a front edge of the reconfigurable chute system 10. The clevises 83 also comprise aligned apertures through which the upper and lower pivot pins 82, respectively, are insertable. The flanges 81 are insertable into the clevises 83 thereby aligning the apertures in the flanges 81 with the apertures in the clevises 83. Insertion of the upper and lower pivot pins 82 through the respective apertures in the upper and lower flanges 81 and the upper and lower clevises 83 pivotably mounts the reconfigurable chute system 10 on the plow 5. The pivot pins 82 comprise threaded ends, which can be threaded into nuts 84 to secure the pivot pins 82 in the apertures. The reconfigurable chute system 10 is therefore pivotable about a vertically-oriented axis so that the reconfigurable chute system 10 can swivel right and left, i.e., laterally.

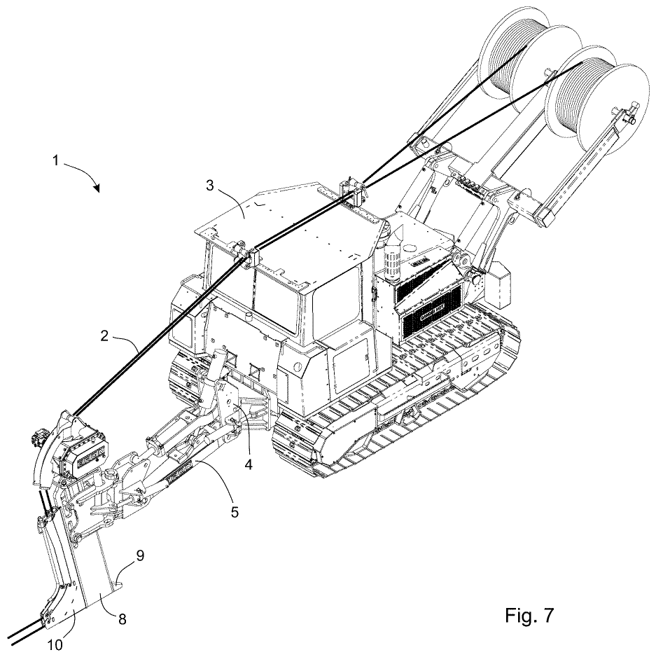

With reference to FIG. 7, a system 1 for installation of continuous elongated tubular material 2 in the ground is shown where the system 1 includes a crawler tractor 3, a plow mount 4 attached to a rear of the tractor 3, and the plow 5 attached to the plow mount 4 with the reconfigurable chute system 10 mounted on the rear of the plow blade 8 of the plow 5.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A reconfigurable chute system for installing continuous elongated tubular material from a plow into the ground, the chute system comprising a plurality of inserts, each insert comprising at least one side wall defining a duct through which a continuous elongated tubular material is fed, each duct having a curved section that directs the continuous elongated tubular material from a substantially vertical orientation at an entrance to the duct downwardly and rearwardly to a substantially horizontal orientation at an exit from the duct,
wherein the plurality of inserts comprises at least a first insert and a second insert, the second insert having a narrower width than the first insert, the second insert nestable with and removably mountable to the first insert while providing a sufficiently large gap in the duct of the first insert between internal walls of the first insert and external surfaces of the second insert to permit feeding of the continuous elongated tubular material through the duct of the first insert.

2. The chute system of claim 1, further comprising a third insert having a narrower width than the first insert and the second insert, the third insert nestable with and removably mountable to the first insert and the second insert while providing a sufficiently large gap in the duct of the first insert or the second insert between internal walls of the first insert or the second insert and external surfaces of the third insert to permit feeding of the continuous elongated tubular material through the ducts of the first insert or the second insert.

3. The chute system of claim 2, wherein the third insert comprises: a tube defining the duct of the third insert; and, a mounting frame connected to the tube, the mounting frame comprising the external surface of the third insert, the mounting frame nestable with and removably mountable to the first insert and the second insert.

4. The chute system of claim 1, wherein the inserts are removably mountable with pinned connections.

5. The chute system of claim 4, wherein the pinned connections comprise pins connecting tops of successively nested inserts to each other.

6. The chute system of claim 1, wherein the ducts of successively nested inserts from the first widest insert to a last narrowest insert are disposed rearwardly of each other.

7. The chute system of claim 1, wherein the first insert comprises a hook on a rear face thereof and proximate a bottom end thereof in which a connecting pin mounted to the second insert is releasably retained to removably mount the second insert to the first insert.

8. The chute system of claim 7, wherein the first insert comprises a hook on a rear face thereof, proximate a middle thereof and before the curved section of the duct in which another connecting pin mounted to the second insert is releasably retained to removably mount the second insert to the first insert.

9. The chute system of claim 2, wherein the first insert or the second insert comprises a hook on a rear face thereof and proximate a bottom end thereof in which a connecting pin mounted to the third insert is releasably retained to removably mount the third insert to the first insert or the second insert.

10. The chute system of claim 9, wherein the first insert or the second insert comprises a hook on a rear face thereof, proximate a middle thereof and before the curved section of the duct in which another connecting pin mounted to the third insert is releasably retained to removably mount the third insert to the first insert or the second insert.

11. The chute system of claim 1, wherein the first insert comprises a plurality of slide plates spanning a width of the duct inside the first insert, the plurality of slide plates providing a guide for the continuous elongated tubular material while being fed through the duct of the first insert.

12. The chute system of claim 1, wherein the first insert is mountable to a blade of the plow.

13. The chute system of claim 1, wherein the continuous elongated tubular material comprises fiber optic cable, coaxial cable, ethernet cable or any combination thereof.

14. A plow for installation of continuous elongated tubular material in the ground, the plow comprising a plow blade and the chute system of claim 1 mounted on the plow blade.

15. The plow of claim 14, wherein the chute system is mounted on a rear of the plow blade.

16. The plow of claim 14, wherein the chute system is pivotably mounted on the plow blade.
